(19) United States
(12) Patent Application Publication
(10) Pub. No.: US 2015/0103551 A1
(43) Pub. Date: Apr. 16, 2015

(54) VEHICULAR HEADLAMP

(71) Applicant: KOITO MANUFACTURING CO., LTD., Tokyo (JP)

(72) Inventor: Hidetada TANAKA, Shizuoka-shi (JP)

(73) Assignee: KOITO MANUFACTURING CO., LTD., Tokyo (JP)

(21) Appl. No.: 14/506,823

(22) Filed: Oct. 6, 2014

(30) Foreign Application Priority Data
Oct. 11, 2013 (JP) 2013-213897

(51) Int. Cl. F21S 8/10

(52) U.S. Cl. CPC F21S 48/1283; F21S 48/115; F21S 48/32; F21Y 2101/02
USPC 362/520

(57) ABSTRACT

A direct projection type vehicular headlamp includes a projection lens having an incident surface and a light emission surface, and a semiconductor light source. A reference surface and a light control surface positioned below the reference surface are provided on the incident surface, and the light control surface is inclined forward with respect to the reference surface in a direction form an upper side to a lower side. The reference surface has a shape to emit from the light emission surface direct light from the semiconductor light source, which has passed through the reference surface and the light emission surface, as substantially parallel light, and the light control surface has a shape to project the direct light from the semiconductor light source, which has passed through the light control surface and the light emission surface, on an upper portion of a predetermined distribution pattern formed by the substantially parallel light.

### INCORPORATION BY REFERENCE

The disclosure of Japanese Patent Application No. 2013-213897 filed on Oct. 11, 2013 including the specification, drawings and abstract is incorporated herein by reference in its entirety.

### BACKGROUND OF THE INVENTION

1. Field of the Invention

The invention relates to a vehicular headlamp.

2. Description of Related Art

Japanese Patent Application Publication No. 2012-190755 (JP 2012-190755 A), for example, describes a vehicular headlamp having a direct projection type optical system. This kind of vehicular headlamp includes a light source, and a projection lens that controls light from the light source and projects it forward. A so-called high beam distribution pattern is formed by the projection lens refracting direct light from the light source so that it becomes parallel light and emitting this parallel light forward of the headlamp. The vehicular headlamp having the direct projection type optical system is able to be manufactured relatively easily because it has few parts.

There is a proposal to form an overhead sign region above the high beam distribution pattern in the vehicular headlamp having the direct projection type optical system, in order to make signs and the like easy to be visually recognized. In the vehicular headlamp described in JP 2012-190755 A, an overhead sign region is able to be formed by forming a gradually changing lens surface on the projection lens. However, with the structure described in JP 2012-190755 A, the gradually changing lens surface is formed on the front surface of the projection lens may detract from the design of the headlamp.

### SUMMARY OF THE INVENTION

The invention thus provides a direct projection type vehicular headlamp that is capable of forming an upwardly expanded radiated region without detracting from the design.

One aspect of the invention relates to a direct projection type vehicular headlamp including: a projection lens having an incident surface and a light emission surface as a convex curved surface; and a semiconductor light source provided near a rear focal point of the projection lens. The projection lens emits direct light from the semiconductor light source as substantially parallel light in front of the headlamp to form a predetermined distribution pattern. A reference surface and a light control surface positioned below the reference surface are provided on the incident surface of the projection lens, and the light control surface is inclined forward with respect to the reference surface in a direction form an upper side to a lower side. In addition, the reference surface has a shape to emit from the light emission surface the direct light from the semiconductor light source, which has passed through the reference surface and the light emission surface, as the substantially parallel light, and the light control surface has a shape to project the direct light from the semiconductor light source, which has passed through the light control surface and the light emission surface, on an upper portion of the predetermined distribution pattern.

According to this structure, direct light from the light source is able to be emitted upward forward of the headlamp by the light control surface, so the radiated area is able to be expanded upward. The light control surface is formed on the incident surface, i.e. a rear surface of the projection lens and a light control surface is not formed on an emitting surface of the projection lens. As a result, the light control surface will not detract from the design of the vehicular headlamp. Therefore, a direct projection type vehicular headlamp that is capable of forming a radiated region that is expanded upward without detracting from the design is able to be provided.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a sectional view of a vehicular headlamp according to one example embodiment of the invention;

FIG. 2 is a sectional view of a projection lens;

FIG. 3 is a view of a distribution pattern formed in front of the lamp by the vehicular headlamp;

FIG. 4 is a view of the projection lens from the rear; and

FIG. 5 is a view corresponding to FIG. 2, of a projection lens mounted in a vehicular headlamp according to a modified example of the invention.

### DETAILED DESCRIPTION OF EMBODIMENTS

Hereinafter, a vehicular headlamp 1 according to one example embodiment of the invention will be described with reference to the accompanying drawings. The vehicular headlamp 1 according to this example embodiment is a so-called direct projection type lamp that emits direct light from a light source in front of the lamp (i.e. the vehicular headlamp 1) via a projection lens.

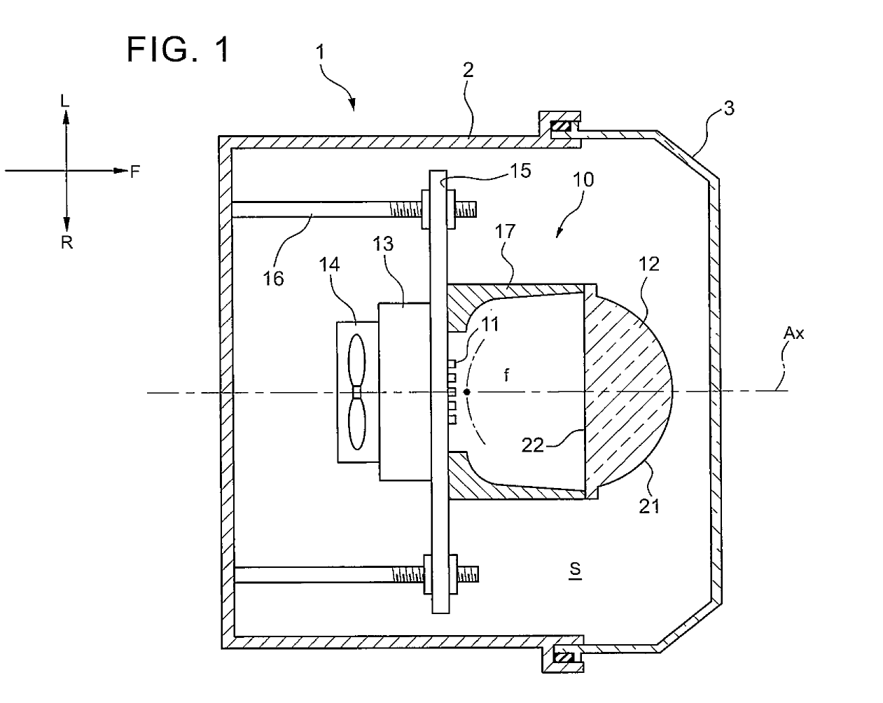

FIG. 1 is a sectional view of the vehicular headlamp 1 according to this example embodiment. In FIG. 1, reference character F indicates a direction forward of the lamp, reference character L indicates a direction to the left of the lamp, and reference character R indicates a direction to the right of the lamp. The vehicular headlamp 1 includes a housing 2 and an outer lens 3. The housing 2 has an opening that opens forward, and the outer lens 3 is attached to the housing 2 so as to close this opening. The housing 2 and the outer lens 3 form a lamp chamber S.

A lamp unit 10 is provided inside the lamp chamber S. This lamp unit 10 includes a plurality of semiconductor light sources 11, a projection lens 12, a heat sink 13, a fan 14, and a bracket 15.

The bracket 15 is a generally plate-shaped member. The bracket 15 is arranged inside the lamp chamber S and a wide surface thereof is oriented in a longitudinal (i.e., front-rear) direction. The heat sink 13 is provided on a surface of the bracket 15 that faces rearward. The fan 14 is provided to the rear of the heat sink 13.

The plurality of semiconductor light sources 11 are mounted on a surface of the bracket 15 that faces forward. The plurality of semiconductor light sources 11 are mounted to the bracket 15 such that light-emitting faces thereof face forward. The plurality of semiconductor light sources 11 are arranged at equidistant intervals in the left-right direction, as shown in FIG. 1. This bracket 15 is mounted to the housing 2 via mounting bolts 16.

The projection lens 12 may be made of transparent resin or transparent glass. The projection lens 12 is mounted to the bracket 15 via a lens mounting portion 17. The projection lens 12 is arranged with an optical axis Ax thereof facing in the longitudinal direction of the lamp.

The projection lens 12 has a light emission surface 21 that is a convex curved surface having a constant curvature, and an incident surface 22. The light emission surface 21 is a surface that faces forward, and the incident surface 22 is a surface that faces rearward. The projection lens 12 is arranged such that a rear focal point f thereof is positioned near the semiconductor light sources 11. More specifically, the semiconductor light sources 11 are arranged to the rear of the rear focal point f of the projection lens 12.

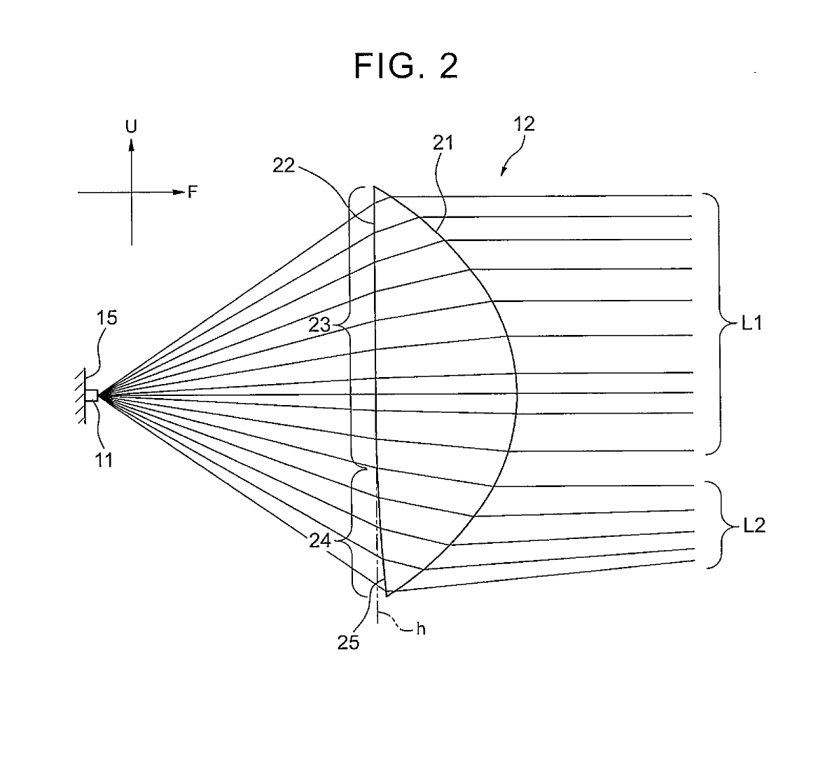

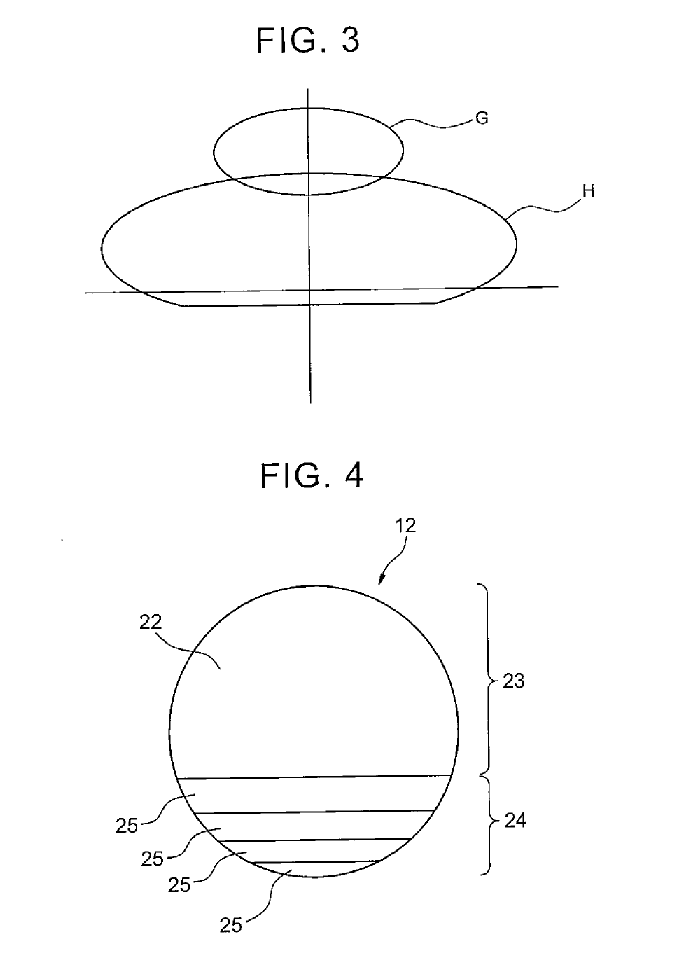

Next, the shape of the projection lens 12 and distribution pattern will be described with reference to FIGS. 2 and 3. FIG. 2 is a longitudinal sectional view of the projection lens 12. In FIG. 2, reference character 2 indicates a direction forward of the lamp, and reference character U indicates a direction above the lamp. FIG. 3 is a view of the distribution pattern formed by the vehicular lamp 1 forward of the lamp.

As shown in FIG. 2, the incident surface 22 of the projection lens 12 has a reference surface 23 and a light control surface 24. In this example embodiment, the reference surface 23 is a planar surface that is orthogonal to the optical axis Ax of the projection lens 12. The light emission surface 21 has a shape in which light incident to the reference surface 23 is emitted as parallel light from the light emission surface 21. That is, direct light from the semiconductor light sources that has passed through the reference surface 23 and the light emission surface 21 becomes parallel light L1 which is emitted forward of the lamp. A high beam distribution pattern H is formed forward of the lamp, as shown in FIG. 3, by this parallel light L1. In this way, light emitted from the semiconductor light sources 11 is directly incident to the projection lens 12 to form a distribution pattern forward of the lamp, so the vehicular headlamp 1 according to this example embodiment is also referred to as a direct projection type vehicular headlamp.

The light control surface 24 is provided continuous with the reference surface 23, below the reference surface 23. A virtual line that extends the cross-section of the reference surface 23 is denoted virtual line h in FIG. 2. The cross-section of the light control surface 24 is inclined forward with respect to the virtual line h in a direction form an upper side to a lower side. Accordingly, a distance between the virtual line h and the light control surface 24 increases in the direction form the upper side to the lower side.

As shown in FIG. 2, the light control surface 24 has a shape in which light that is emitted in front of the lamp from the light emission surface 21 through the light control surface 24 is directed upward. That is, direct light from the semiconductor light sources 11 that has passed through the light control surface 24 and the light emission surface 21 becomes upward light L2 and emitted in front of the lamp. A region G above the high beam distribution pattern H formed in front of the lamp is illuminated, as shown in FIG. 3, by this upward light L2. This region G may be provided partially overlapping with the high beam distribution pattern H, or may be provided above the high beam distribution pattern H and separated from the high beam distribution pattern H.

FIG. 4 is a view of the projection lens 12 from the rear. As shown in FIG. 4, the light control surface 24 includes a plurality of planar surfaces 25 arranged in the vertical direction. Each of the planar surfaces 25 extends in the left-right direction. Also, each of the planar surfaces 25 is inclined forward with respect to the reference surface 23 in the direction from an upper side to a lower side, and a lower planer surface 25 has a larger inclination angle with respect to the reference surface 23. Therefore, light emitted from the light emission surface 21 through one of the lower planar surfaces 25 is emitted farther upward than light emitted from the light emission surface 21 through one of the upper planar surfaces 25. In FIG. 4, for descriptive purposes, the edge line of adjacent planar surfaces 25 are clearly illustrated to make it easy to distinguish between the planar surfaces 25, but this edge line does not have to be clear. Also, the planar surfaces 25 may be connected by a continuous curve so as not to have an edge line.

With the vehicular headlamp 1 according to this example embodiment, light is projected on the region G above the high beam distribution pattern H by the light control surface 24, so the visibility above the high beam distribution pattern is increased. The shapes of the light control surface 24 and the reference surface 23 differ, so the shape of the incident surface 22 is uneven. However, this incident surface 22 faces the rear of the lamp, and is thus not easily visible from the front of the lamp. Therefore, even if the shape of the incident surface 22 is uneven due to the light control surface 24 being provided, the incident surface 22 is not visible directly from the outside, so it will not detract from the design of the vehicular headlamp 1. That is, the direct projection type vehicular headlamp 1 that is capable of forming an upwardly expanded radiated region without detracting from the design is able to be provided.

Also, with the vehicular headlamp 1 according to the example embodiment, the shape of the light emission surface 21 does not have to be changed to project light on the region G above the high beam distribution pattern H. Therefore, the shape of the incident surface 22 is able to be a convex curve having a uniform curvature, so the design of the vehicular headlamp 1 is able to be even further increased.

Unlike this example embodiment, when a bulb light source such as a filament bulb is used as the light source, the light from the bulb light source includes a lot of infrared components, so the projection lens tends to become high in temperature. Therefore, when a light control surface having a complex shape is formed in a position close to the bulb light source, this light control surface may deform due to the heat. Therefore, the light control surface is typically provided on the light emission surface. However, the infrared components included in the light emitted from a semiconductor light source such as an LED element are few compared to light emitted from a bulb light source. Therefore, in this invention, the light control surface is provided on the incident surface, so high visibility is realized by forming a complex light distribution pattern without detracting from the design of the lamp.

Also, with the vehicular headlamp 1 according to this example embodiment, the light control surface 24 includes the plurality of planar surfaces 25 arranged in the vertical direction. Therefore, light emitted from the light emission surface 21 through the light control surface 24 is able to be diffused over a broad area in the vertical direction, thus enabling a broad area in the vertical direction to be illuminated.

Also, with the vehicular headlamp 1 according to this example embodiment, the plurality of semiconductor light sources 11 lined up in the left-right direction are positioned farther to the rear than the rear focal point f of the projection lens 12. Arranging the plurality of semiconductor light sources 11 lined up in the left-right direction enables a wide light distribution pattern to be formed in the left-right direction. At this time, unlike this example embodiment, if the semiconductor light sources 11 are positioned at the rear focal point of the projection lens 12, the images of the semiconductor light sources 11 would be projected as it is in front of the lamp, and dark portions due to the gaps between the plurality of semiconductor light sources 11 would be formed in front of the lamp. On the other hand, when the semiconductor light sources 11 are positioned to the rear of the rear focal point f of the projection lens 12, as they are in this example embodiment, portions of the images of the adjacent semiconductor light sources 11 are projected in front of the lamp with overlapping each other. Therefore, a wide light distribution pattern that is continuous in the left-right direction is able to be formed without dark portions due to the gaps between the semiconductor light sources 11 being projected onto the lamp.

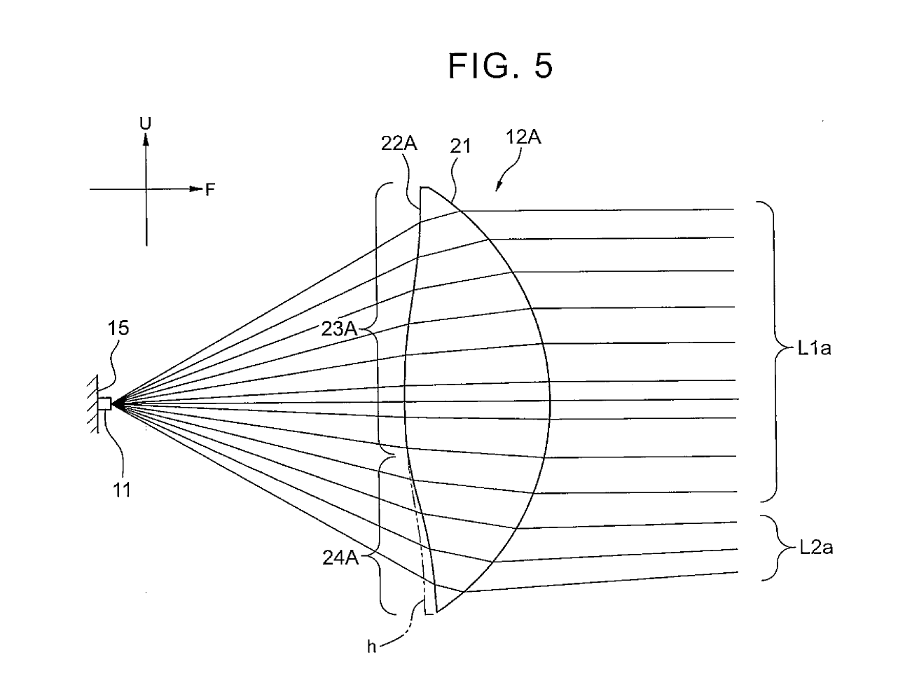

The shape of the projection lens 12 is not limited to the example described above. For example, the reference surface may be formed by a curved surface as shown in FIG. 5, instead of a planar surface. FIG. 5 is a view corresponding to FIG. 2, of a projection lens 12A mounted to a vehicular lamp according to a modified example of the invention. In the description below, members similar to those described above will be denoted by like reference characters, and descriptions of those members will be omitted.

As shown in FIG. 5, the projection lens 12A includes a light emission surface 21 that is a convex curved surface, and an incident surface 22. The incident surface 22 includes a reference surface 23A formed by a curved surface, and a light control surface 24A formed below the reference surface 23A. In this modified example, reference surface 23A is a curved surface that protrudes rearward near the optical axis Ax of the projection lens 12, and is recessed toward the front farther away from the optical axis Ax, as shown in FIG. 5. This reference surface 23A also has a shape in which direct light from the semiconductor light sources 11 that has passed through the reference surface 23A and the light emission surface 21 becomes parallel light L1a and is emitted in front of the lamp. A high beam distribution pattern H such as that shown in FIG. 3 is formed ahead of the lamp by this parallel light L1a.

Also, as shown in FIG. 5, the light control surface 24A is provided continuous with the reference surface 23A below the reference surface 23A. In FIG. 5, a virtual line that extends from the cross-section of the reference surface 23A is denoted as virtual line h. The cross-section of the light control surface 24A is inclined forward with respect to the virtual line h in a direction from an upper side to a lower side. That is, the light control surface 24A has a shape inclined forward with respect to the reference surface 23A in the direction form upper side to the lower side. Accordingly, a distance between the virtual line h and the light control surface 24A increases in the direction form the upper side to the lower side.

As shown in FIG. 5, the direct light from the semiconductor light sources 11 that has passed through the light control surface 24A and the light emission surface 21 becomes upward light L2a and is emitted in front of the lamp. A region G such as that shown in FIG. 3 is illuminated in front of the lamp by this upward light L2a.

In the example embodiment and modified example described above, an example is described in which the semiconductor light sources 11 are aligned in the left-right direction, but the semiconductor light sources 11 may also be aligned in the vertical direction or in a planar shape. Alternatively, a single semiconductor light source 11 may be used.

As explained above in detail, one aspect of the invention relates to a direct projection type vehicular headlamp including: a projection lens having an incident surface and a light emission surface as a convex curved surface; and a semiconductor light source provided near a rear focal point of the projection lens. The projection lens emits direct light from the semiconductor light source as substantially parallel light in front of the headlamp to form a predetermined distribution pattern. A reference surface and a light control surface positioned below the reference surface are provided on the incident surface of the projection lens, and the light control surface is inclined forward with respect to the reference surface in a direction form an upper side to a lower side. In addition, the reference surface has a shape to emit from the light emission surface the direct light from the semiconductor light source, which has passed through the reference surface and the light emission surface, as the substantially parallel light, and the light control surface has a shape to project the direct light from the semiconductor light source, which has passed through the light control surface and the light emission surface, on an upper portion of the predetermined distribution pattern.

According to this structure, direct light from the light source is able to be emitted upward forward of the headlamp by the light control surface, so the radiated area is able to be expanded upward. The light control surface is formed on the incident surface, i.e. a rear surface of the projection lens and a light control surface is not formed on an emitting surface of the projection lens. As a result, the light control surface will not detract from the design of the vehicular headlamp. Therefore, a direct projection type vehicular headlamp that is capable of forming a radiated region that is expanded upward without detracting from the design is able to be provided.

The predetermined light distribution patter may be a high beam distribution pattern. According to this structure, the upper portion of the high beam distribution pattern is able to be illuminated.

The light control surface may include a plurality of planar surfaces extending in a left-right direction. In this case, each of the plurality of planar surfaces may be inclined forward with respect to the reference surface in the direction form the upper side to the lower side, and the plurality of planar surfaces may be arranged such that a lower planer surface of the plurality of planar surfaces has a larger inclination angle with respect to the reference surface. According to this structure, light is diffused by the light control surface, such that the radiated area is able to be expanded in the vertical direction.

The semiconductor light source may include a plurality of light sources arranged in a left-right direction, and the semiconductor light source may be positioned to a rear of the rear focal point of the projection lens. According to this structure, linear dark portions due to the spaces between the semiconductor light sources tend not to form in front of the vehicular headlamp.

What is claimed is:

1. A direct projection type vehicular headlamp comprising:
a projection lens having an incident surface and a light emission surface as a convex curved surface; and
a semiconductor light source provided near a rear focal point of the projection lens, wherein:
the projection lens emits direct light from the semiconductor light source as substantially parallel light in front of the headlamp to form a predetermined distribution pattern;
a reference surface and a light control surface positioned below the reference surface are provided on the incident surface of the projection lens, and the light control surface is inclined forward with respect to the reference surface in a direction form an upper side to a lower side;
the reference surface has a shape to emit from the light emission surface the direct light from the semiconductor light source, which has passed through the reference surface and the light emission surface, as the substantially parallel light; and
the light control surface has a shape to project the direct light from the semiconductor light source, which has passed through the light control surface and the light emission surface, on an upper portion of the predetermined distribution pattern.

2. The vehicular headlamp according to claim 1, wherein the predetermined light distribution patter is a high beam distribution pattern.

3. The vehicular headlamp according to claim 1, wherein:
the light control surface includes a plurality of planar surfaces extending in a left-right direction;
each of the plurality of planar surfaces is inclined forward with respect to the reference surface in the direction form the upper side to the lower side; and
the plurality of planar surfaces are arranged such that a lower planer surface of the plurality of planar surfaces has a larger inclination angle with respect to the reference surface.

4. The vehicular headlamp according to claim 1, wherein the semiconductor light source includes a plurality of light sources arranged in a left-right direction, and the semiconductor light source is positioned to a rear of the rear focal point of the projection lens.
